(19) United States
(12) Patent Application Publication
(10) Pub. No.: US 2007/0022041 A1
(43) Pub. Date: Jan. 25, 2007

(54) Method and System for Improving Exchange Performance

(76) Inventors: Bryan T. Durkin, Orland Park, IL (US); Thomas G. McGabe, Chicago, IL (US); Laurence M. Ratner, Deerfield, IL (US)

Correspondence Address: MCCRACKEN & FRANK LLP, 200 W. ADAMS STREET, SUITE 2150, CHICAGO, IL, 60606, US

(21) Appl. No.: 11/458,540

(22) Filed: Jul. 19, 2006

Related U.S. Application Data
(60) Provisional application No. 60/701,724, filed on Jul. 22, 2005.

(51) Int. Cl. G06Q 40/00

(52) U.S. Cl. 705/37

(57) ABSTRACT

A method for operating an exchange where financial instruments are traded that includes applying a discriminant to trade transactions, dividing the trade transactions into groups and then routing trade transactions to selected exchanges for handling. The method also allows transactions to be matched within each exchange and allows qualified traders to make manual trades within the various exchanges.

This application claims the benefit of U.S. provisional Ser. No. 60//701,724, filed Jul. 22, 2005, the disclosure of which is hereby incorporated by reference in its entirety.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to a system and method for handling trade transactions. More particularly, this invention relates to separating the trade transactions into various groups and automatically routing some of the groups to an alternate exchange that may include a matching engine where the trade transactions can be executed thereby improving the overall efficiency of a market.

2. Description of the Background of the Invention

In a typical exchange, traders will make trade transactions by utilizing face-to-face communication techniques in an open outcry market environment. Financial instruments include stocks, bonds, futures, options, cash, and other similar instruments. The concept of a financial instrument in today's marketplace can include a wide variety of items that have extended far beyond what was originally considered a financial instrument. This includes contracts for the future delivery of agricultural and other commodities, including metals, oils, and the like. Also, the financial instrument can be a derivative instrument that includes options of all types and instruments that are based on a basket of other instruments such as options based on the Dow Jones Industrial Average, currency exchange baskets and the like. A trade transaction can be the buying and selling of any of the above financial instruments and similar instruments as well as similar rights and obligations.

At most exchanges, brokers receive orders from their respective firms. These orders may arrive at a firm's order entry desk and may be entered into an order desk computer. The order desk computer may be integrated with the exchange's network infrastructure and order routing systems. The order entered into the order desk computer can be routed to a trading pit on the floor of the exchange to a broker workstation. Some of these orders are small or may be for a transaction that is outside the current market. One example is a limit order to buy or sell at a price below or above the current active market price range. Forwarding these out of market or small trades to the floor broker interferes with the operation of the exchange, especially during very busy periods on the floor.

Within the open outcry environment, brokers use hand signals to indicate their willingness to execute a trade transaction at or near the prevailing bid/offer in the open outcry pit. When a broker successfully executes a trade transaction, the execution data related to the trade transaction is entered into the broker workstation by the broker or by a clerk on behalf of the broker. The data from the broker workstation is then transmitted to the order routing system of the exchange for clearing. This data may be enhanced by including customer information, billing or delivery information that does not impact the key market data that underlies the trade transaction.

In addition to brokers, the pit also includes traders who trade financial instruments for themselves. Traders can have computer systems for recording their trade transactions. These computer systems can also be integrated into the exchange's network infrastructure and order routing systems. Upon execution of a trade, trade execution data is transmitted to an order routing system of the exchange to be forwarded to a clearing system.

During periods of very high market activity, the open outcry pit may be very congested. At these times, a broker/trader may be unable to successfully communicate his willingness to execute a trade transaction with other market participants. This results in the broker's/trader's inability to execute a trade transaction at the optimum bid/offer price. Because these markets can be highly volatile, the inability to execute a trade transaction at the broker's/trader's preferred price point may lead to significant market inefficiencies. The system of one embodiment of the present invention allows an exchange to set one or more thresholds, evaluate incoming trade transactions on the basis of the threshold and automatically route the trade transaction to the open outcry exchange or an alternate market, such as an electronic trading engine.

This system will significantly alleviate congestion in a trading pit and thereby increase market efficiency. Because an exchange can base its choice of threshold on the level of activity on a trading floor at any particular time, the system can adjust to periods of high or low market activity.

Some exchanges currently use various electronic systems to drive the markets. Some systems allow small investors to create and manage a complex portfolio of financial instruments in a cost effective basis. Additionally, this system improves the small investor's ability to execute trade transaction by aggregating the small investor's trade orders with other market participants orders at various times. This provides the small investor with efficient access to the markets at a lower cost than would have been achieved if the small investor's order were executed individually.

Also, some exchanges have established a system for routing certain orders, depending on the size of the order, to specific trading firms in a round robin-fashion. Such systems allow automatic execution of those orders routed to a trading firm assuming the trading firm has sufficient exposure to fill the order.

Additionally, other exchanges employ systems that allocate commissions and fees to individual traders and/or trading firms while the trader or trading firm is trading financial instruments at accelerated levels. Such systems reward traders who participate in the market or their involvement and also minimize the likelihood of erroneous assignment of commission and fees to the wrong trader and/or trading firm in a situation where there is a frenzy of activity on a trading floor.

Other exchanges also have a system that enables direct interaction between a user and a trader in a trading pit who is using an electronic trading desk. Such systems are designed for use in parallel with an existing order delivery electronic system to provide uninterrupted access to a market when the existing system fails.

The small order exchange system “SOES” is also used in some exchanges. SOES provides individual or small investors who generally trade on their own accounts quick access to the markets. SOES significantly decreases the advantages of market makers and larger institutional investors over small investors in the markets. Small investors can enter their orders directly into SOES. The SOES automatically executes such orders against corresponding matching orders that are available in the market.

### SUMMARY OF THE INVENTION

One embodiment of the present invention is directed to a method of handling trade transactions based on at least one discriminant. This method includes the step of separating the trade transactions into a plurality of groups of trade transactions using the discriminant. The method also includes the step of automatically routing the trade transactions that are within a first group to a first exchange, where the trade transactions outside the first group are sent to a second exchange. The method also includes the step of matching an individual trade transaction that has been sent to the first exchange either with other trade transactions that have been sent to the first exchange or with a manual trade transaction entered by a qualified trader.

Another embodiment of the present invention is directed to a method of handling trade transactions based on at least one discriminant. This method includes the step of associating a trader with a trade transaction. The method also includes the step of separating the trade transactions into a plurality of groups of trade transactions using the discriminant. The method further includes the step of automatically routing the trade transactions that are within a first group to a first exchange, where the trade transactions outside the first group are sent to a second exchange. The method also includes the step of matching an individual trade transaction that has been sent to the first exchange either with other trade transactions that have been sent to the first exchange or with a manual trade transaction entered by a qualified trader. In addition, the method includes the steps of crediting the associated trader with a matched trade transaction and also routing the matched trade transaction to a clearing system.

### BRIEF DESCRIPTION OF THE DRAWINGS

FIG. 1 is a schematic view of one embodiment of a system architecture of the present invention;

FIG. 2 is a flow diagram illustrating one embodiment of the present invention;

FIG. 3 is a table showing various discriminants that may be used along with possible routing actions an exchange might choose;

FIG. 4 illustrates a user interface that a trader/broker may use to view available bids and offers in the alternate exchange;

FIG. 5 is a flow diagram illustrating yet another embodiment of the present invention;

FIG. 6 is a flow diagram of still another embodiment of the present invention; and

FIG. 7 is a flow diagram of a still further embodiment of the present invention.

### DETAILED DESCRIPTION OF THE PREFERRED EMBODIMENTS

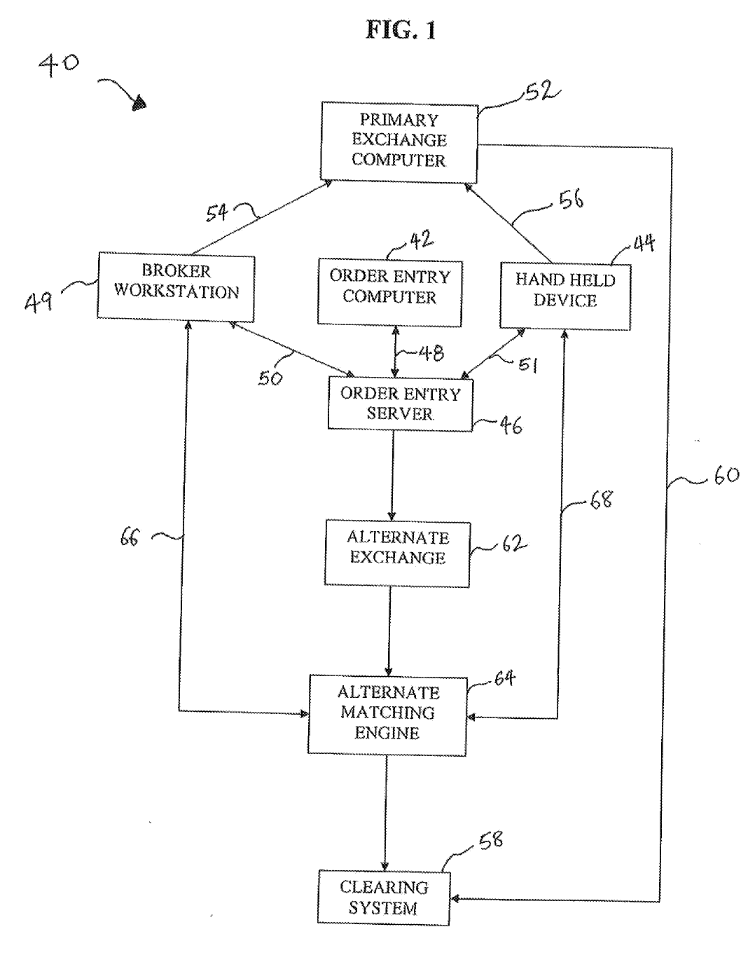

FIG. 1 shows an overview of a system architecture of a trading system 40 of the present invention. The trading system 40 is a system for separating trade transactions into different groups based on one or more chosen discriminants. These different groups of trade transactions are routed to an alternate exchange or to a trading floor. Depending on the system, there may be a second alternate exchange to which a further group of trade transactions is routed.

A clerk enters a trade transaction into the trading system 40 via an order entry computer 42. The order entry computer 42 can be any type of computer typically used in an exchange environment including computers located near the trading floor or pit including the order desk computer, custom programmed computers using an API provided by the exchange or computers running software used by the exchange to record and enter orders into the exchange's computer system. A trader may use a hand held device 44 to enter a trade transaction into the trading system 40. The hand held device 44 is programmed to enable traders to enter key data about a trade, such as the nature of the financial instrument traded, i.e., July 2007 Corn, the type of transaction, i.e., buy or sell, the price, and the quantity. There can be multiple order entry computers 42 or multiple hand held devices 44 connected to the trading system 40 at any one time. The order entry computer 42 and the handheld device 44 are connected to an order entry server 46 by interfaces 48 and 51, respectively.

One aspect of the order entry server 46 separates trade transactions based on a chosen discriminant or discriminants and determines where the trade transaction should be routed for handling. Based on the discriminant, certain trade transactions will be sent to an alternate exchange 62 or routed to the trading floor face-to-face trading. Trade transactions to be traded on the trading floor are sent by the order entry server 46 to a broker workstation 49 or to the same hand held device 44 or a different hand held device 44 from one that is associated with or entered the trade transaction through interfaces 50, or 51, respectively. In this case, the broker will trade the order in the customary manner in open outcry floor or pit. It should be apparent that the order entry computer 42 and the broker workstation 49 may be part of the same system and in some instances may even the same computing device. Interfaces 48, 50, and 51 may provide two-way communication between the appropriate device and order entry server 46.

In the open outcry environment, individuals use hand signals to indicate willingness to make a trade at a particular price point. When the trade is concluded, the trade data will be sent to the primary exchange computer 52 through interfaces 54 or 56 depending on whether the order was initially entered via the workstation 49 or the hand held device 44. The primary exchange computer 52 may include a matching engine to pre-match certain trade transactions prior to the trade transaction being sent to a clearing system 58. In addition, the primary exchange computer 52 will enable the broker's or the trader's firm to add enhancement data to the basic trade transaction data that has been entered into the primary exchange computer 52. Eventually, the trade transaction data will be sent to the clearing system 58 through interface 60 for matching processing, and balancing. It should be noted that in some environments, the order entry server 46 and the primary exchange computer 52 can be the same computer.

Trade transactions that meet the requirements of the discriminant in the order entry server 46 are routed to the alternate exchange 62 that may include a matching engine 64. At this point, the matching engine 64 will automatically match the trade transaction using well known matching algorithms. In some cases, an immediate match may occur within alternate exchange matching engine 64 if an opposite trade transaction that has not been matched exists on the alternate exchange matching engine 64. For example, electronic matching may occur in the alternate exchange matching engine 64 when there is an opposite trade transaction that matches the price and quantity. Also, qualified individuals may be able to access trade transactions that are not automatically matched at the alternate exchange matching engine 64 through the broker workstation 49 or the hand held device 44 and interfaces 66 and 68, respectively. The threshold for the qualification of individuals to access the alternate exchange matching engine 64 may be specified by an exchange. Trade transactions that are matched automatically by the alternate exchange matching engine 64 or matched by orders directly placed on the alternate exchange matching engine 64 by individuals who access the alternate exchange matching engine 64 through interfaces 66 and 68 are also sent to the clearing system 58 for processing.

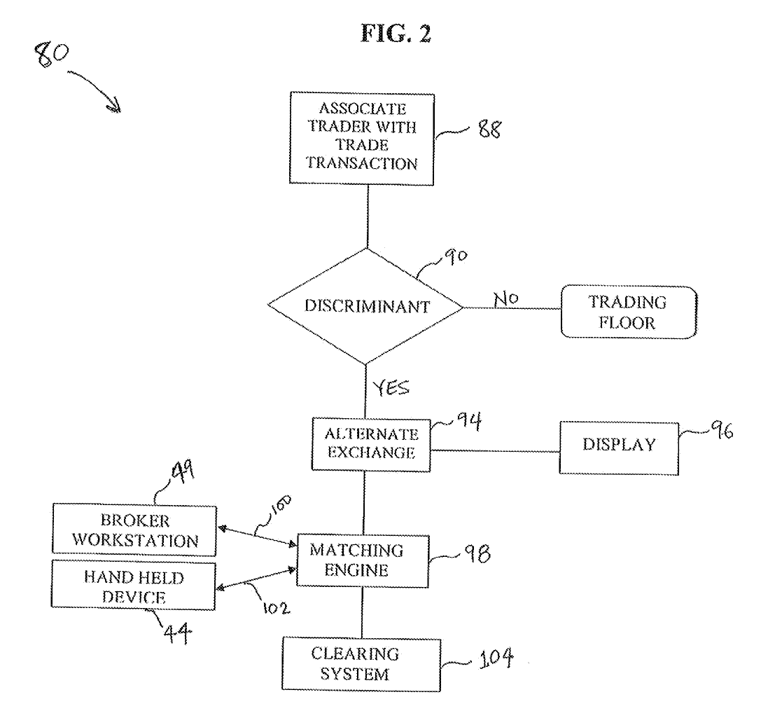

With reference to FIG. 2, an order for a trade transaction is entered into order workstation 49 or hand held device 44. The order is received within the order entry server 46. Within the order entry server 46, an optional block 88 associates the received trade transaction with a trader and/or brokerage firm who would have filled the order in the open outcry environment. Thereafter, control then passes to a block 90 that compares a discriminant to the order, for example, the discriminant is the size of the order and the discriminant value is 10 contracts. If the order is greater than or equal to the discriminant value, in the above example orders of 10 contracts or more, the order will be routed via the “No” branch to a block 92 that sends the order to the broker associated with the order for handling on the exchange floor. However, if the order is less than the discriminant value, in the above example the order is for less than 10 contracts, control will pass via the “Yes” branch to the alternate exchange 94. Some embodiments of the present invention include a display device 96 that displays orders for trade transactions that have been routed to alternate exchange 94. Display device 96 displays all the pertinent information regarding the orders that are available on the alternate exchange 94.

Alternate exchange 94 may include matching engine 98. Matching engine 98 will use well known algorithms to automatically match trade transactions. In some cases, an immediate match may occur within matching engine 98 when there is an opposite trade transaction that matches the price and quantity of the entered order. Additionally, qualified individuals may be able to access trade transactions that are not automatically matched within matching engine 98. Based on thresholds set by an exchange, qualified individuals may be able to match trade transactions within matching engine 98 via their broker workstations 49 and hand held devices 44 through interfaces 100 and 102. Trade transactions that are matched automatically by matching engine 98 or by matched orders directly placed on the matching engine 98 by individuals who access the matching engine 98 through interfaces 100 and 102 are sent to a clearing system 104 for immediate or end of day processing. In some embodiments of the present invention, processing includes crediting the traders/brokers on the buy side and the sell side of a trade transaction with trade transactions that were entered by them and matched within the alternate exchange 94.

In some embodiments of the present invention, alternate exchange 94 also may employ the method of separating trade transactions based on various discriminants as described above to further route trade transactions to other additional alternate exchanges.

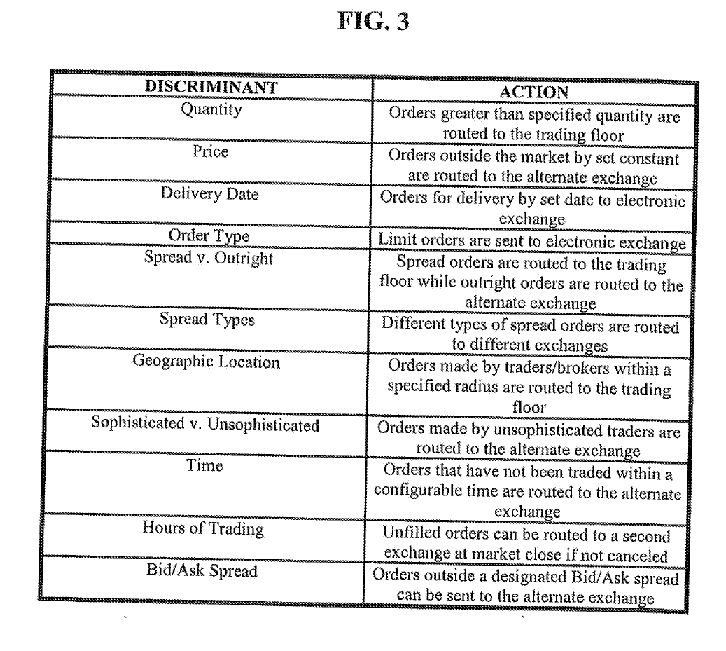

In FIG. 3, a series of potential discriminants that could be used in the present invention are listed and along with how an order might be routed using these discriminants. Other discriminants are also possible. For discriminants based on the size of the order, those orders that are larger than the discriminant will be sent to the trading floor while those that are smaller will be sent on to the alternate exchange. Another discriminant that may be used is price. For example, an individual may enter an order for a trade transaction to be executed at a certain price or with a range of prices. An exchange may choose to route orders at prices within a certain price range with respect to the prevailing market price to the alternate exchange while orders outside of the specified price range are routed to the trading floor.

The contract date of orders is yet another discriminant that may be employed by the present invention. Contracts that are for deferred or illiquid months may be routed to the alternate exchange while orders to be delivered at an earlier date may be routed to the trading floor and vice-versa. For instance, if an exchange is experiencing high volumes of trade transactions with respect to September corn, the exchange may choose to route all orders for January corn to an alternate exchange to enable more efficient trading of September corn on the trading floor.

Another discriminant that may be used by the present invention is the individual type. Individuals can be separated into various groups using several classifications. Some classifications that may be used to separate individuals are net assets, individual traders or funds, hedgers or speculators, sophisticated individuals or unsophisticated individuals, and retail or professional traders. Type of orders may also be used as a discriminant by separating them into outright orders or spread orders. An exchange may choose to route outright orders to the alternate exchange and route spread orders to the trading floor. Also, an exchange could choose to route different types of spread transactions such as straddles, condors, and other strategies to separate exchanges. The geographical origin of an order may also be used as a discriminant. Orders entered by traders within a certain radius of the exchange facility may be routed to an alternate exchange while orders originating outside the specified radius may be routed to the trading floor and vice-versa. In other embodiments of the present invention, orders pending in the order entry server 46 for a configurable period of time can be routed to the alternate exchange 62. Another example of a discriminant is the use of hours of trading. In this instance, a trade that has not been executed at the close of trading at a first exchange, and had not been indicated as good only for that trading session could be routed for trading to a second exchange for possible execution. It should be apparent that other discriminants can be used to select an exchange for a trade transaction. Similarly, other characteristics can be used to separate trades into different groups.

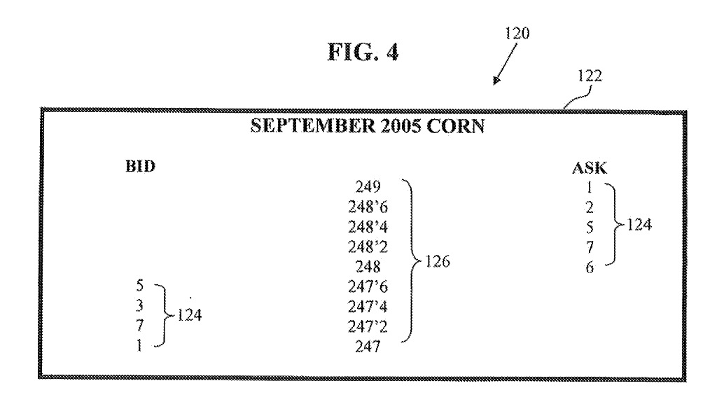

FIG. 4 shows a screen shot of another embodiment of the present invention. The display device 120 shows the market available on the alternate exchange 48. The display 120 can be an integrated display on the hand held device 44 or some portion or all of the display of the broker workstation 49. A display screen 122 had arrayed a series of orders for September 2005 Corn including the amount 124 of contracts that market participants are willing to buy or sell at the various prices 126. The display can be programmed to show a certain level of market depth.

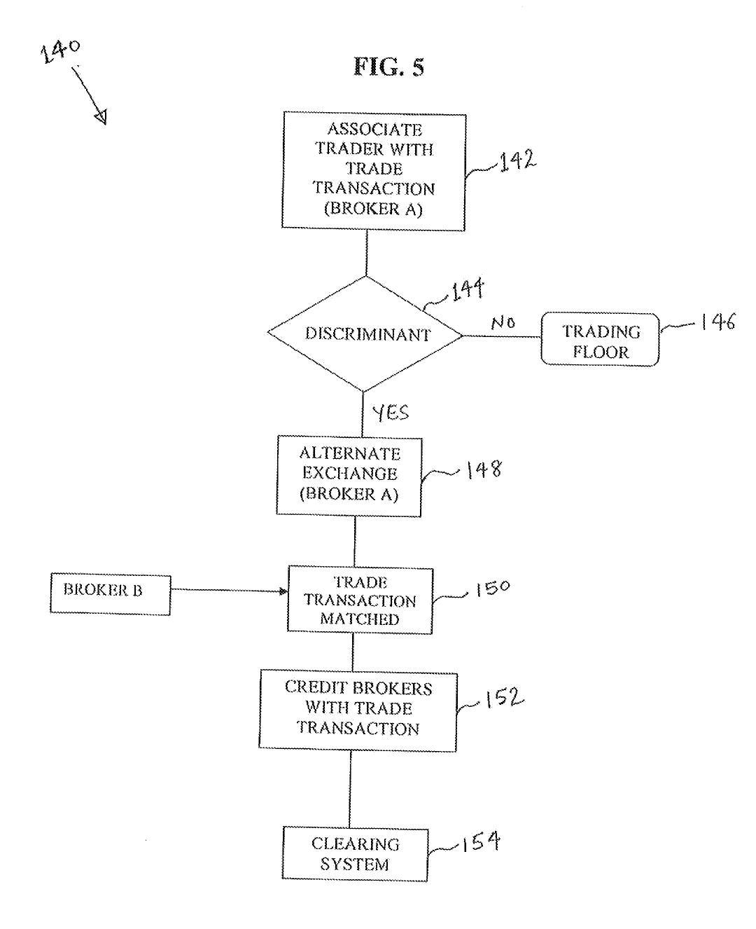

In FIG. 5, a further embodiment of the present invention is illustrated as system 140. A block 142 within the order entry server 46 receives an order for a trade transaction. Block 142 associates broker A with the received order. Control then passes to a block 144 that applies a discriminant to the order. If the order does not meet the requirements of the discriminant, the order will be routed via the “No” branch to a block 146 that sends the order to broker A for handling on the exchange floor. However, if the order meets the requirements of the discriminant, control will pass via the “Yes” branch to the alternate exchange 148. The alternate exchange 148 may include an alternate exchange matching engine 150. In this instance, the alternate exchange 148 will send the order to the alternate exchange matching engine 150. If there is a corresponding opposite trade transaction within alternate exchange matching engine 150, an automatic match will occur within matching engine 150. The alternate exchange 148 may also be a secondary trading floor where orders are processed in a face-to-face environment. If the match is made using an alternate exchange matching engine, the matching engine 150 credits broker A with his side of the matched trade transaction and hands over control to clearing system 154 for processing. In a similar fashion the face-to-face trades are also sent to the clearing system 154 for processing.

However, if an automatic match did not occur within matching engine 150, Broker B may access matching engine 150 through broker workstation 49 or hand held device 44 via interfaces 66 and 68, respectively. Broker B may choose to match broker A's order by making a corresponding opposite entry into matching engine 150 through broker workstation or hand held device 44. At this point, a match occurs and broker A and broker B both get credited for their respective side of the trade transaction. The matched trade is sent by a block 152 to the clearing system 154 for processing.

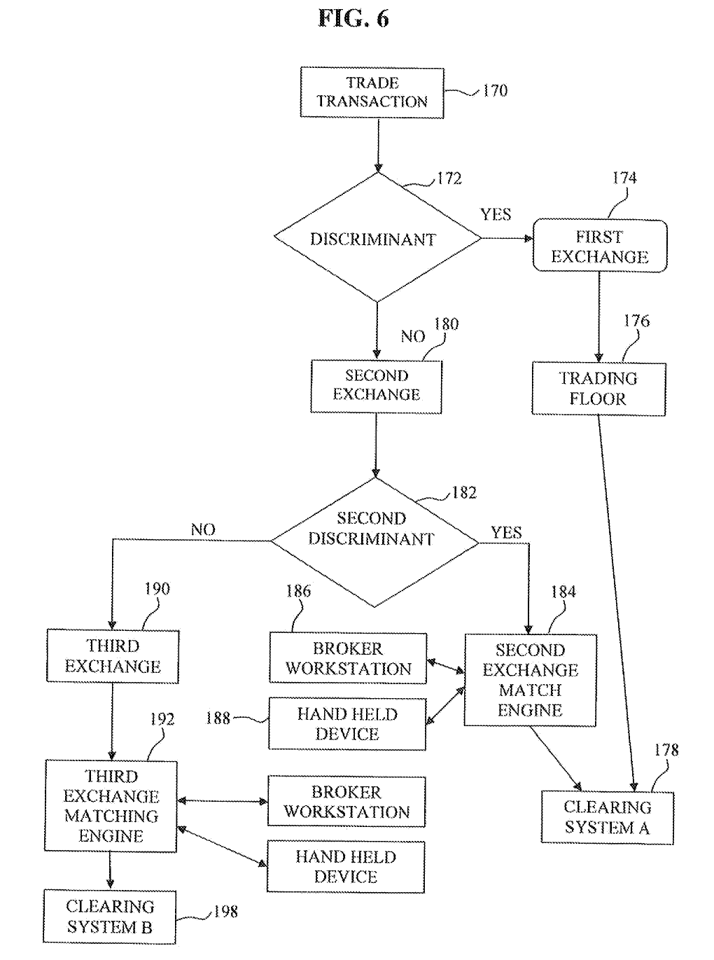

With reference to FIG. 6, an embodiment is shown where two discriminants are applied sequentially. A trade transaction 170 is received by an exchange. A first discriminant 172 is applied to the trade transaction 170. If the trade transaction 170 is greater than the first discriminant 172, for instance the size of the trade transaction 170 is greater than 5 units, the trade transaction 170 is routed via the “Yes” branch to the first exchange 174 and then on to a trading floor 176 for normal handling on the trading floor 176. Once the trade transaction 170 is match on the trading floor 176, the trade transaction 170 is sent to a clearing system A 178. The clearing system A will process the trade transaction 170 in the normal fashion for a matched trade transaction.

If the trade transaction 170 is less than the first discriminant 172, then the trade transaction 170 is routed via the “No” branch to a second exchange 180. At the second exchange 180, a second discriminant 182 is applied to the trade transaction 170. As an example, the second discriminant might look to see if the price of the trade transaction 170 is within a certain number of ticks, for example 5 ticks, of the market. If the price of the trade transaction 170 is within 5 ticks, the trade transaction 170 is routed via the “Yes” branch to a second exchange match engine 184. At the second exchange match engine 182, the trade transaction 170 can be matched with other trade transactions that have been sent to the second exchange match engine 184. In addition as above, a qualified broker or trader for the first exchange 174 can also query the second exchange match engine 184, and place orders directly on the second exchange match engine 184 using a broker workstation 186 or a hand held device 188. Once the trade transaction 170 is matched by the second exchange matching engine 184, the trade transaction is also sent to the clearing system A 178 where the trade transaction 170 is processed in the normal fashion.

If the trade transaction 170 is smaller than the first discriminant 172 and also more than 5 ticks outside the market, then the trade transaction 170 is routed via the “No” branch to a third exchange 190. Because the third exchange is an electronic exchange, the trade transaction 170 is sent to a third exchange matching engine 192. At the third exchange matching engine 192, the trade transaction 170 can be matched by other similar orders or the third exchange matching engine 192 can be queried and accessed directly by qualified brokers and traders as above using a broker workstation 194 or a hand held device 196. If the trade transaction 170 is matched at the third exchange matching engine 192, the trade transaction is sent to a clearing system B 198 for post trade processing. In some environments, the clearing system A 178 and the clearing system B 198 can communicate so that trade transactions at either of the clearing systems A or B 178, 198 can be offset against each other. In other embodiments, the clearing system A 178 and the clearing system B 198 will be separate.

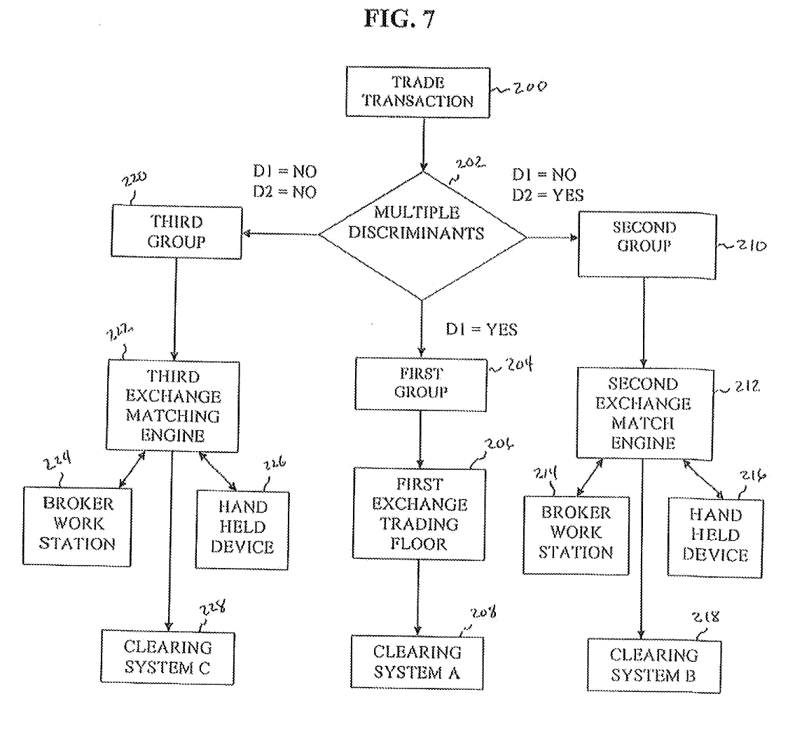

FIG. 7 shows an embodiment where multiple discriminants are applied at the same time. A trade transaction 200 is compared against multiple discriminants 202. For example, if an exchange is particularly busy, only trades for financial instruments with certain delivery dates will be trade on the exchange floor. All other trade transactions 200 will be routed for handling in other exchanges. If D1 is for corn with a September 2006 delivery date and D2 is for orders of more than 5 contracts, then in a situation where D1 is true or Yes, that is trade transaction 200 is a contract for September 2006 corm, the multiple discriminants 202 will send trade transactions 200 via the branch where “D1=Yes” to a first group 204 that will be traded on a first exchange trading floor 206. In this instance, the discriminants D1 and D2 are being tested sequentially. Therefore as long as D1 is true, the trade transaction will be routed by the “D1=Yes” branch. In other instances, each discriminant can be tested independently. For this situation, there would be both a “D1=Yes and D2=Yes” and a “D1=Yes and D2=No” branch. As trade transactions 200 are matched on the first exchange trading floor 206, the matched trade transactions re sent for post trade processing to a clearing system A 208. For situations where D1 is false or No, i.e., the contract is not for September 2006 corn, and where D2 is true or Yes, the order is for more than 5 contracts, the trade transaction 200 will be sent via the “D1=No and D2=Yes” branch to a second group 210. The second group 210 is then routed to a second exchange match engine 212 for matching as above. In this instance, qualified brokers and traders can also participate in the market using broker workstations 214 or hand held devices 216. Once the trade is matched, the matched trades are sent to a clearing system B 218. For situations where D1 and D2 are both false, then the trade transaction 200 is routed via the “D1=No and D2=No” branch to a third group 220. At the third group 220 the trade transaction 200 is sent to a third exchange matching engine 222. Because the third exchange is an electronic exchange, qualified brokers and traders can participate in the market broker workstations 224 or hand held device 226. If the trade transaction 200 is match, the match transaction is sent to a clearing system C 228. Either or both of the second and third exchanges could also be face to face exchanges with a trading floor. In fact all three exchanges can be electronic, or face-to-face. Further, some or all of the clearing system A 208, clearing system B 218, or clearing system C 228 can cooperate or be totally independent.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications, which come within the scope of the appended claims, are reserved.

I/we claim:

1. A method of handling trade transactions based on at least one discriminant, the method comprising the steps of:
separating the trade transactions into a plurality of groups of trade transactions using the discriminant;
automatically routing the trade transactions that are within a first group to a first exchange, wherein the trade transactions outside the first group are sent to a second exchange; and
matching an individual trade transaction that has been sent to the first exchange either with other trade transaction that have been sent to the first exchange or with a manual trade transaction entered by a qualified trader.

2. The method of claim 1, wherein the discriminant is the size of the trade transaction.

3. The method of claim 1, wherein the discriminant is the type of financial instrument being traded.

4. The method of claim 1, wherein the discriminant is the delivery date or the trade transaction.

5. The method of claim 1, wherein the discriminant is the type of the trade transaction.

6. The method of claim 1, wherein the discriminant is the length of time an order has been pending without having been executed.

7. The method of claim 1, wherein the discriminant is a combination of a first discriminant and a second discriminant.

8. The method of claim 7, wherein there is a second group based on the second discriminant and the second group is routed to a third exchange.

9. The method of claim 7, wherein the first discriminant is the size of the trade transaction and the second discriminant is the type of financial instrument being traded.

10. The method of claim 7, wherein the first discriminant is the size of the trade transaction and the second discriminant is the delivery date of the trade transaction.

11. The method of claim 7, wherein the first discriminant is the size of the trade transaction and the second discriminant is the type of the trade transaction.

12. The method of claim 1 that includes the step of associating the trade transaction that has been sent to the first exchange with a trader who would have handled the trade on a trading floor.

13. The method of claim 1 that includes the step of crediting the trade transaction that has been send to the first exchange to a trader who would have handled the trade on a trading floor.

14. The method of claim 1, wherein the second exchange is an open outcry exchange with a trading floor.

15. The method of claim 1, wherein the first exchange is an electronic exchange.

16. The method of claim 1, wherein the qualified trader is trading in the second exchange.

17. The method of claim 1, wherein a portion of the individual trade transaction is matched.

18. The method of claim 1, wherein the individual trade transaction matches a portion of another trade transaction.

19. A method of handling trade transactions based on at least one discriminant, the method comprising the steps of:
associating a first trader with a trade transaction;
separating the trade transactions into a plurality of groups of trade transactions using the discriminant;
automatically routing the trade transactions that are within a first group to an alternate exchange, wherein the trade transactions outside the first group are sent to another exchange;
matching an individual trade transaction with other trade transactions within the group of trade transactions sent to the alternate exchange or with a manual trade transaction entered by a qualified second trader on the trading floor;
crediting the first trader with a matched trade transaction; and
routing the matched trade transaction to a clearing system.

20. The method of claim 19, wherein the discriminant is the size of the trade transaction.

21. The method of claim 19, wherein the discriminant is the type of financial instrument being traded.

22. The method of claim 19, wherein the discriminant is the delivery date of the trade transaction.

23. The method of claim 19, wherein the discriminant is the type of the trade transaction.

24. The method of claim 19, wherein the discriminant is the length of time an order has been pending without having been executed.

25. The method of claim 19, wherein, the discriminant is a combination of a first discriminant and a second discriminant.

26. The method of claim 25, wherein there is a second group based on the second discriminant and the second group is routed to a third exchange.

27. The method of claim 25, wherein the first discriminant is the size of the trade transaction and the second discriminant is the type of financial instrument being traded.

28. The method of claim 25, wherein the first discriminant is the size of the trade transaction and the second discriminant is the delivery date of the trade transaction.

29. The method of claim 25, wherein the first discriminant is the size of the trade transaction and the second discriminant is the type of the trade transaction.

30. The method of claim 19, wherein the qualified second trader is trading in the second exchange.

31. The method of claim 19, wherein a portion of the individual trade transaction is matched.

32. The method of claim 19, wherein the individual trade transaction matches a portion of another trade transaction.
